(19) United States
(12) Patent Application Publication
(10) Pub. No.: US 2006/0061811 A1
(43) Pub. Date: Mar. 23, 2006

(54) Image processing apparatus, image processing method, and computer product

(76) Inventor: Akira Murakata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/226,319

(22) Filed: Sep. 15, 2005

(30) Foreign Application Priority Data
Sep. 16, 2004 (JP) 2004-269375
Jul. 25, 2005 (JP) 2005-214787

(51) Int. Cl. G06F 3/12

(52) U.S. Cl. 358/1.15

(57) ABSTRACT

An image processing apparatus acquires image information and collateral information. The collateral information includes illegitimate-copy-detection information that indicates whether the image information is an illegitimate copy. When the illegitimate-copy-detection information indicates that the image information is an illegitimate copy, the image processing apparatus outputs the image information in an unreadable form.

### CROSS-REFERENCE TO RELATED APPLICATIONS

This application is based upon and claims the benefit of priorities from Japanese Patent Application No. 2004-269375, filed on Sep. 16, 2004, and 2005-214787 filed on Jul. 25, 2005, the entire contents of which are incorporated herein by reference.

### BACKGROUND OF THE INVENTION

1. Field of the Invention

The present invention relates to a technology for performing image processing on digital image data in a digital multifunction product.

2. Description of the Related Art

Digital copiers such as multifunction peripheral (MFP) copiers can perform a wide variety of image processings at a high speed. In the MFP copier, a user can make various settings from an operating unit. As a result, an image processing controller in the MFP copier has a complex structure.

An Application Specific Integrated Circuit (ASIC) or a Digital Signal Processor (DSP) is used to control image processing in a digital copier. The DSP has become popular recently, because, it has some advantages. For example, when the DSP is used, various types of image processings can be performed by only switching programs and data.

However, the image processing controller that controls the DSP becomes more complex with increased variation in image processing. Moreover, because a user can easily modify image processing specifications, the image processing controller needs to respond quickly and reliably to the modifications, which requires frequent image processing control. This requires the image processing controller to not only meet various requests from the operating unit, but also to respond to modifications in the image processing specifications. Furthermore, because the DSP is more expensive than the ASIC, an image processing that is unlikely to be modified significantly is carried out with the ASIC. Thus, the image processing controller is also required to select or combine image processing devices according to the intended use.

MFP copiers are provided with more advanced and sophisticated features. Specifically, various applications such as a printer connected to a network, a scanner, a facsimile etc. are added to the MFP copier in addition to the copying function. Moreover, the MFP copier can be used simultaneously in multiple ways. For example, while one user is making a large number of copies, another user can printout documents from a network. As a result, the image processing controller is required to perform resource control. When the MFP copier is to be used simultaneously for multiple purposes, the image processing controller manages a status of the resource that is currently being used, and if multiple processes cannot be executed simultaneously, the image processing controller notifies a wait status in response to a subsequent process request.

While image processing is carried out by the DSP to achieve advanced functions, digitized image information can be easily processed and edited. Therefore, a need arises for a security measure against illegitimate use of information. Particularly, a copy can be easily made with a digital copying machine, and therefore, security should be provided for digital image information. As one security measure achieved by the DSP, a user can embed a certain pattern in an image that is inhibited from being copied, and the DSP recognizes the pattern through image processing.

Japanese Patent Application Laid-Open Nos. 2001-203836 (video bus control apparatus), 2001-223865 (image processing apparatus), and 2002-207606 (image processing apparatus) disclose technologies relating to DSP apparatuses that perform image processing. However, the disclosed apparatuses do not address complex requests from a copying machine or the like. Furthermore, each apparatus is not configured as a component of a single DSP control apparatus, and therefore, major changes are needed when incorporating the apparatus to a similar image processing apparatus. FIG. 16A and FIG. 16B are functional block diagrams of conventional image processing controllers employing ASIC and DSP, respectively. The configuration of the ASIC shown in FIG. 16A lacks flexibility, because a portion that translates information input from the operation unit to information interpretable by the control apparatus is integrated with a portion that issues a download request based on the translated information. Thus, when a specification is changed, the entire system must be changed.

In the configuration of the DSP shown in FIG. 16B, a portion that translates information input from the operation unit to information interpretable by the DSP control apparatus, a portion that converts the translated information to detailed information for allowing the DSP to download information, and a portion that requests the DSP to download information based on the converted information are separated from one another. Thus, even when the specification is changed, minimum change in the system is required.

However, the conventional configurations shown in FIG. 16A and FIG. 16B do not take into account modifying the control software for each image processing device or managing the resources. Since the control software can not be easily modified according to the conventional configurations, it is desirable that an incorporation type image processing controller, such as a digital copying machine, is configured so as to be modularized to be used in various types of devices and to facilitate incorporation work. It is also desirable that a mechanism to grasp the states of mounted devices and switch their controls is incorporated into the image processing controller, and the control method is changed according to the means of achieving image processing, thereby allowing plural types of device controls to be incorporated in a single image processing controller, or plural devices to be used at one time through resource management to achieve advanced functions.

Recent copying machines have an additional function of storing plural pieces of digitized text data. With such copying machines, image information received from a client personal computer connected to the network can be stored, or image information scanned by a copying machine used as a scanner can be stored. There are several ways of inputting the stored text data to a copying machine. For example, the text data can be read out by a scanner of a different company or can be transmitted from a copying machine. Accordingly, it is necessary to appropriately print out the stored image data by performing image processing using optimal image processing parameters, and to prevent illegitimate copies from being made.

### SUMMARY OF THE INVENTION

It is an object of the present invention to at least solve the problems in the conventional technology.

According to an aspect of the present invention, an image processing apparatus includes an acquiring unit that acquires image information and collateral information, wherein the collateral information includes illegitimate-copy-detection information that indicates whether the image information is an illegitimate copy; and an output unit that outputs the image information in an unreadable form when the illegitimate-copy-detection information indicates that the image information is an illegitimate copy.

According to another aspect of the present invention, a method includes acquiring image information and collateral information, wherein the collateral information includes illegitimate-copy-detection information that indicates whether the image information is an illegitimate copy; and outputting the image information in an unreadable form when the illegitimate-copy-detection information indicates that the image information is an illegitimate copy.

According to still another aspect of the present invention, a computer-readable recording medium stores therein a computer program that implements a method according to the present invention on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a copying machine exemplifying an image processing apparatus according to an embodiment of the present invention;

FIG. 2 is a diagram of the fundamental concept of an image processing controller according to the embodiment;

FIG. 3 is a block diagram of an image processing system in the image processing apparatus shown in FIG. 1;

FIG. 4 is a diagram depicting relationships between processes of StoM and MtoP in the image processing system shown in FIG. 3;

FIG. 5 is a flowchart of a processing procedure performed by the image processing controller shown in FIG. 2 and FIG. 3;

FIG. 6 is a sequence diagram of a single process for a stored text performed by the image processing controller;

FIG. 7 is a flowchart of a processing procedure performed by an interface-protocol managing unit shown in FIG. 6;

FIG. 8 is a diagram of an information reference structure of a detailed-information conversion managing unit shown in FIG. 6;

FIG. 9 is a flowchart of a process (StoM) of downloading a program and data to an image processing device shown in FIG. 3 and FIG. 4 prior to image scanning;

FIG. 10 is a flowchart of a process (StoM) of downloading a program and data to the image processing device after image scanning;

FIG. 11 is a flowchart of a download setting process (MtoP) performed prior to image printing;

FIG. 12 is a flowchart of a download setting process (MtoP) performed after image printing;

FIG. 13 is a flowchart of a download setting process (MtoP) performed prior to image printing for a copy operation and a stored text operation;

FIG. 14 is a flowchart of a download setting process (MtoP) performed each time after image printing;

FIG. 15 is a block diagram of a hardware configuration of a multifunction product according to the embodiment;

FIG. 16A is a diagram of a conventional image processing apparatus (ASIC); and

FIG. 16B is a diagram of a conventional image processing apparatus (DSP).

### DETAILED DESCRIPTION OF THE PREFERRED EMBODIMENTS

Exemplary embodiments of the present invention will be described below with reference to accompanying drawings. The present invention is not limited to these embodiments.

An image processing apparatus, which is a digital multifunction product, according to an embodiment of the present invention performs image processing on digital image data.

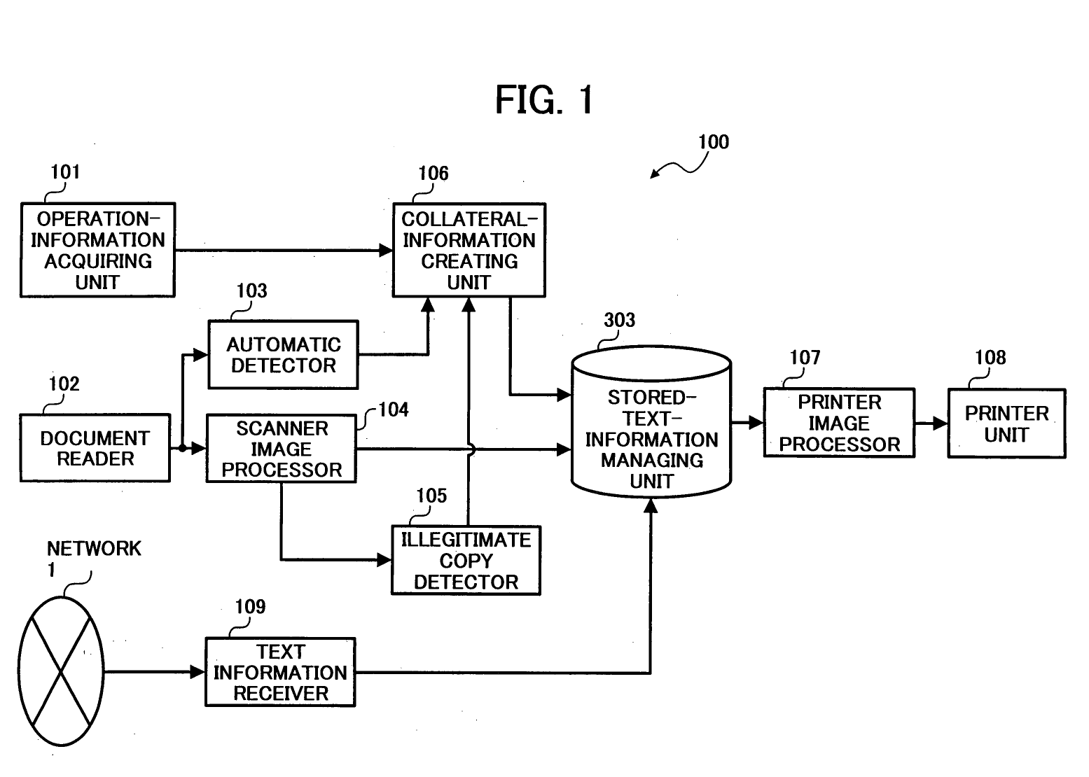

For the sake of explanation, a copying machine 100 is considered as an example of the image processing apparatus. FIG. 1 is a block diagram of the copying machine 100. The copying machine 100 includes an operation-information acquiring unit 101, a document reader 102, an automatic detector 103, a scanner image processor 104, an illegitimate copy detector 105, a collateral-information creating unit 106, a stored-text-information managing unit 303, a printer image processor 107, a printer unit 108, and a text information receiver 109. The copying machine 100 is connected to another multifunction product (not shown), a scanner (not shown), and the like over a network 1.

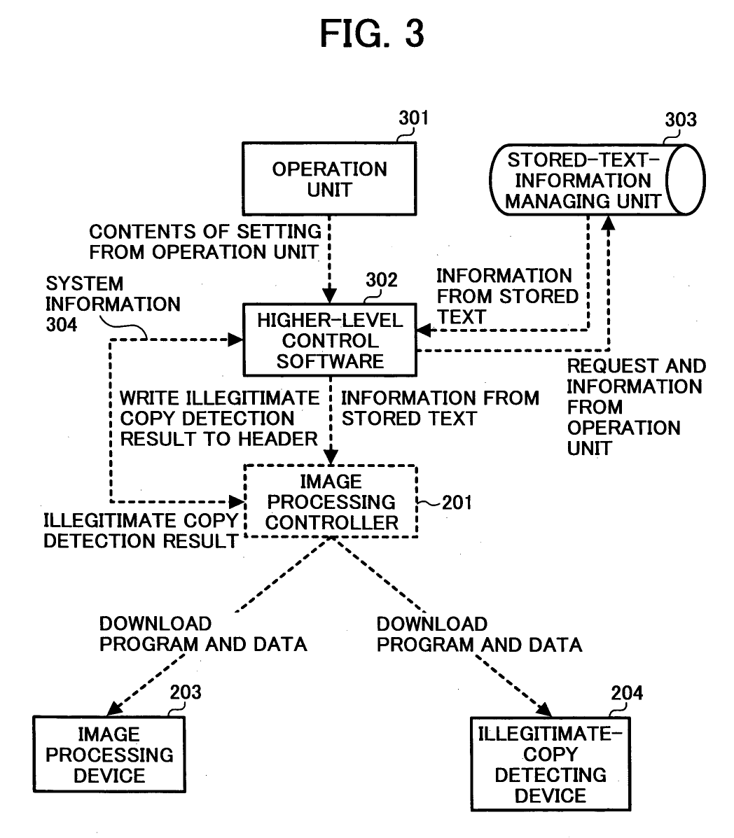

The operation-information acquiring unit 101 receives various operation information input through an operation unit 301 (shown in FIG. 3). The document reader 102 reads image information of a document scanned by a scanner, and converts the image information to digital image data. The automatic detector 103 detects automatically detectable information, such as the document size and the density thereof, from the digital image data.

The scanner image processor 104 performs general scanner image processing on the digital image data. The scanner image processor 104 is realized by downloading a program and data, which correspond to the scanner image processing, to a DSP (not shown).

The illegitimate copy detector 105 determines whether a scanned document is a copy-permitted document or an illegitimate copy (hereinafter, “illegitimate-copy-detection information”) by using image data processed by the scanner image processor 104. The illegitimate copy detector 105 is realized by downloading a program and data corresponding to an illegitimate-copy detecting processing to another DSP.

The collateral-information creating unit 106 creates collateral information corresponding to the image information read by the document reader 102 based on the operation information acquired by the operation-information acquiring unit 101, the information detected by the automatic detector 103, and the illegitimate-copy-detection information detected by the illegitimate copy detector 105.

The stored-text-information managing unit 303 stores the image information read by the document reader 102 in association with the collateral information that includes the illegitimate-copy-detection information. Since the illegitimate-copy-detection information indicates whether the stored image information is an illegitimate copy, it is possible to effectively prevent outputting of image information that is prohibited from being copied. Since the illegitimate-copy-detection information is stored in association with the corresponding image information, an illegitimate copy can be prevented by using the illegitimate-copy-detection information without performing the illegitimate-copy detecting processing on the image information again.

The printer image processor 107 reads the image information and the collateral information from the stored-text-information managing unit 303 and performs general printer image processing. When the illegitimate-copy-detection information indicates that the image information is an illegitimate copy, the image information is output in an unreadable form. The unreadable form is a state that the output image is completely filled with a predetermined color such as black. The printer image processor 107 is realized by downloading a program and data corresponding to the printer image processing to the DSP. The printer image processor 107 can directly acquire image information from the scanner image processor 104 and operation information from the operation-information acquiring unit 101 instead of the image information and the collateral information stored in the stored-text-information managing unit 303, and perform the printer image processing.

The printer unit 108 outputs the image information subjected to the printer image processing in the printer image processor 107.

The text information receiver 109 receives text information including image information and collateral information transmitted from the multifunction product or the scanner connected to the network 1, and stores the text information in the stored-text-information managing unit 303. Since there is information indicating whether the image information transmitted over the network and stored in the stored-text-information managing unit 303 is an illegitimate copy, it is also possible to effectively prevent outputting of image information that is prohibited from being copied. Even when an image processing apparatus to which image information is transmitted does not perform the illegitimate-copy detecting processing, it is possible to effectively prevent outputting of image information that is prohibited from being copied.

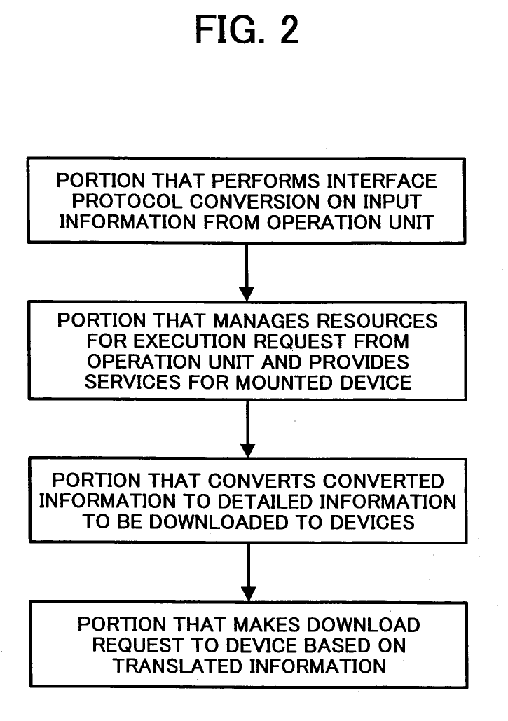

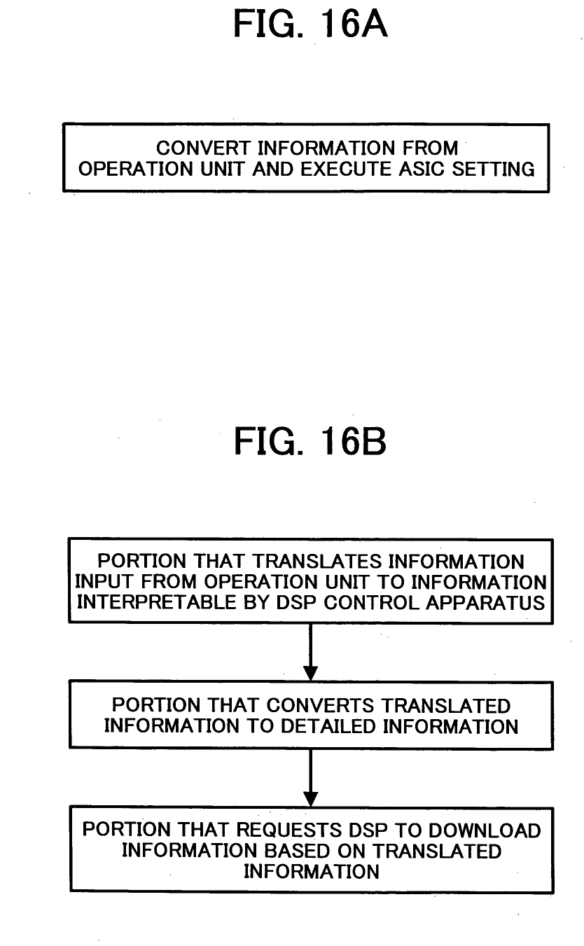

A process of realizing the processes of the scanner image processor 104, the illegitimate copy detector 105, and the printer image processor 107 by the DSP will be explained below. The fundamental concept of an image processing controller according to the embodiment will be explained with reference to FIG. 2. The configuration shown in FIG. 2 corresponds to the configuration shown in FIG. 16B added with a concept of resource management for an execution request from the operation unit 301 (shown in FIG. 3) and a concept of providing services to mounted devices, thus ensuring simultaneous use of multiple devices and plural types of control using a single controller, by considering the resources and the mounted devices. Further, an internal information converting portion is separated from a portion that converts converted information to detailed information for downloading information to a device.

FIG. 3 is a block diagram of an image processing system in the image processing apparatus according to the embodiment, including the portion that downloads a program and data to the DSP. The image processing apparatus includes the operation unit 301 that inputs a request by a user, the stored-text-information managing unit 303 that handles a stored text and information on the stored text, a higher-level control software 302 that manages information from the operation unit 301 and information from the stored-text-information managing unit 303, an image processing device 203, an illegitimate-copy detecting device 204, and an image processing controller 201 that controls information to be downloaded to the image processing device 203 and a resource state.

The image processing device 203 includes at least one ASIC, DSP, or the like that achieves image processing based on information downloaded from the image processing controller 201.

The operation unit 301 can set various requests made by a user. The information from the operation unit 301 is separated into tasks by the higher-level control software 302 serving as a service layer, depending on the contents of the setting and the time at which the setting has been made, and the information is then transmitted as a process to the image processing controller 201. The higher-level control software 302 simultaneously transfers the information from the stored-text-information managing unit 303 and the information from the operation unit 301 to the image processing controller 201. Based on the information of different request levels from the operation unit 301 and the information from the stored-text-information managing unit 303, the image processing controller 201 converts the information to a program and data that are to be set in the image processing device 203. The information from the operation unit 301 has a higher priority than the information from the stored-text-information managing unit 303, and the operation unit 301 can designate a copy operation (operation without information storage) and an operation of re-printing a stored text.

The image processing controller 201 first determines whether a read request for application information selected by the user should be processed only with the information from the operation unit 301 or also using the information from the stored-text-information managing unit 303. Information that is determined as unnecessary is not read. The image processing controller 201 inquires the higher-level control software 302 about system information 304. This information is changed when, at the design stage, an image processing unit (IPU) board is changed and the types and the number of the image processing devices 203 and the illegitimate-copy detecting devices 204, both mounted on that board, are changed. The system information 304 is used for determining what kind of IPU board is currently mounted, and how many image processing devices 203 and illegitimate-copy detecting devices 204 are mounted. The image processing controller 201 grasps the types and the number of control targets and the mounting status of the IPU board from the system information 304, so that a single image processing controller can perform download control at any design stage.

The information from the operation unit 301 makes various requests, such as application information designated by the user, the mode level such as a character mode, a function level of directly designating the program number for a Microsoft tape format (MTF) filter, and a service personnel command. The information from the stored-text-information managing unit 303 is information that corresponds to the collateral information, such as the character mode selected by the operation unit 301 when the user has saved the text information, information on the density of the document, illegitimate-copy-detection information, and the like. The image processing controller 201 converts the information to detailed information to be downloaded to the image processing device 203 and the illegitimate-copy detecting device 204. The image processing controller 201 downloads the information to internal memories of the image processing device 203 and the illegitimate-copy detecting device 204 based on the program and the data converted by the image processing controller 201 itself. After the downloading, the image processing device 203 and the illegitimate-copy detecting device 204 execute the image processing and the illegitimate-copy detecting processing based on the downloaded program and data.

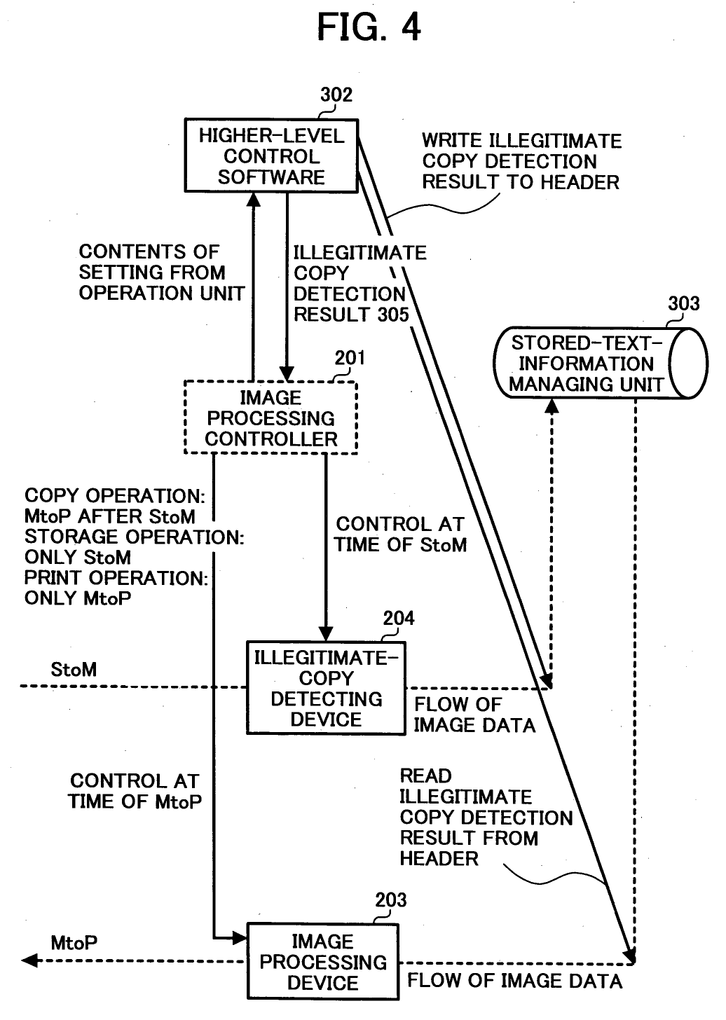

The process executed by the DSP to which the program and the data are downloaded is explained next. As shown in FIG. 4, the processes are classified into scan to memory (StoM) and memory to print (MtoP), which are copy operations, scan to memory (StoM) which is a storage operation, and memory to print (MtoP), which is a print operation. At the time of the StoM operation, the image processing controller 201 makes an inquiry to the DSP that detects whether an illegitimate copy is being made (i.e. the illegitimate-copy detecting device 204), and determines whether such copy is attempted. The image processing controller 201 sends the result of determination to the higher-level control software 302. The higher-level control software 302 writes this illegitimate-copy-detection result 305 to the stored-text-information managing unit 303 as header information for the scanned image. Accordingly, the illegitimate-copy-detection result 305 determined by the illegitimate-copy detecting device 204 at the time of StoM operation is stored for each image scanned, and at the time of the MtoP operation, the image is printed out as a readable or an unreadable image based on the illegitimate-copy-detection result 305.

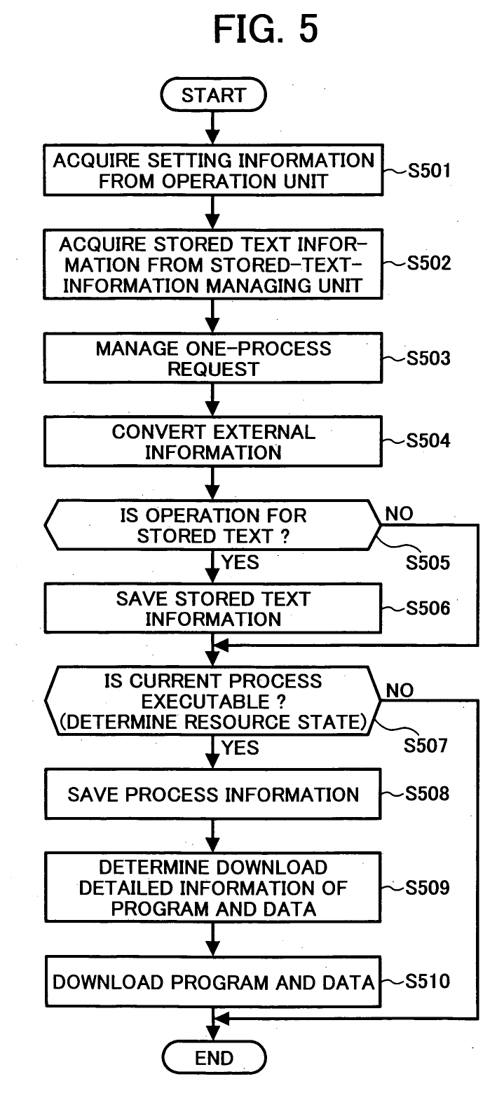

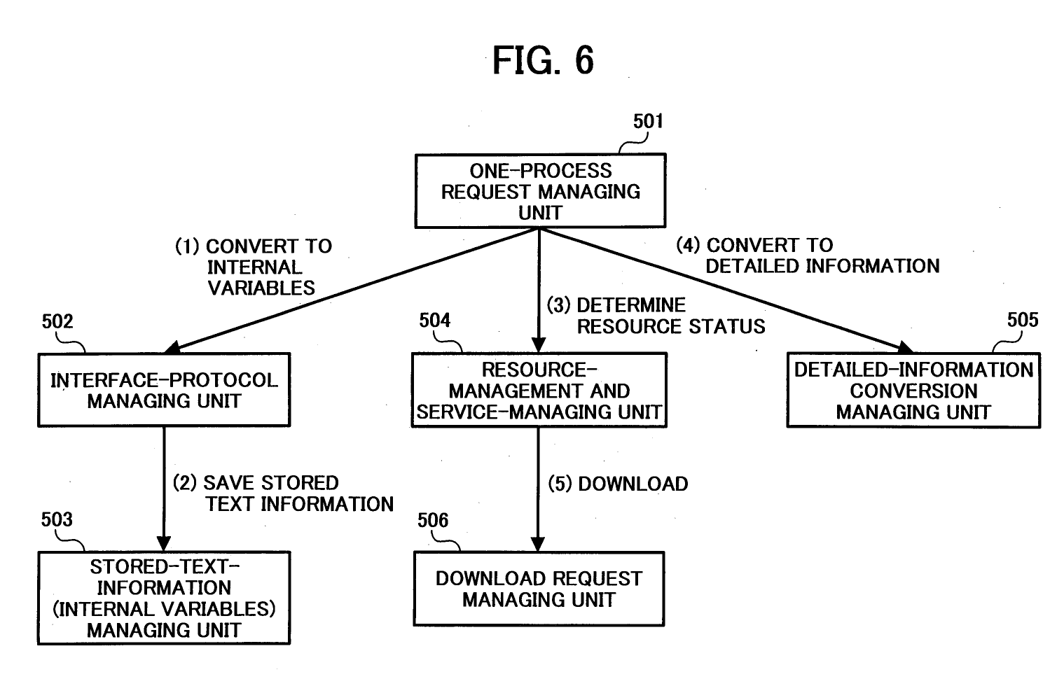

FIG. 5 is a flowchart of a processing procedure performed by the image processing controller 201. FIG. 6 is a sequence diagram of a single process for a stored text performed by the image processing controller 201. The image processing controller 201 acquires a request (setting information) from the system user through the operation unit 301 (step S501). The request includes various kinds of information, such as process information, the character mode, the size, the density of the document, the magnification, the number of the MTF filter, and the like. The image processing controller 201 acquires information from the stored-text-information managing unit 303 (step S502). Based on the received information, the image processing controller 201 performs one-process request management with respect to a current request by a one-process request managing unit 501 (portion that performs a request management with respect to a single execution request) (step S503). The image processing controller 201 requests an interface-protocol managing unit 502 (portion that performs interface protocol conversion management of the input information from the operation unit 301 and the information of a stored text) to convert the external information (operation unit information) from the operation unit 301 to internal variables, and saves the internal variables in a detailed-information conversion managing unit 505 (portion that converts converted information to detailed information for downloading the information to the device) (step S504). This process corresponds to a process (1) shown in FIG. 6. Although conversion of external information to internal variables increases the number of the processes, this prevents subsequent processings performed by the image processing controller 201 from being altered by influence of external information. After application information, which is included in the information from the operation unit 301, is converted to internal variables, the interface-protocol managing unit 502 determines whether the current process is for the stored text (step S505). When it is determined that the process is for the stored text (Yes at step S505), the stored text information is saved in a stored text information (internal variables) managing unit 503 (portion that stores information of the stored text subjected to interface protocol conversion) (step S506). This process corresponds to a process (2) shown in FIG. 6.

After the conversion to the internal variables including process information, the one-process request managing unit 501 requests a resource-management and service-managing unit 504 (portion that performs resource management with respect to the execution request and provides services to mounted devices) to determine a resource state that corresponds to a process (3) shown in FIG. 6 (step S507). Specifically, a resource to be acquired is determined based on a resource state acquired in the past and the current process information, and it is determined whether the current process is executable. When it is determined that the process is executable (Yes at step S507), the process information is saved (step S508), and the system control proceeds to a process (4) shown in FIG. 6. On the other hand, when it is determined that the process is not executable (No at step S507), the higher-level control software 302 is informed of a standby state and is instructed to send a request again.

The one-process request managing unit 501 requests the detailed-information conversion managing unit 505 to determine detailed information corresponding to the program and data to be downloaded (step S509), and sends a download request for the program and data to the detailed-information conversion managing unit 505. The detailed-information conversion managing unit 505 converts the information to detailed information by referring to the saved contents of the internal variables and the stored text information. The detailed information, which is an abstract concept, is used instead of directly using the internal variables and the stored text information for downloading information to the image processing device 203, thereby enhancing reusability.

In a process (5) shown in FIG. 6, the resource-management and service-managing unit 504 sends the detailed information (information converted by the detailed-information conversion managing unit 505) and the stored text information to a download-request managing unit 506 (portion that makes download setting to the device) that manages driver control of the image processing device 203 that is currently mounted, and the download-request managing unit 506 executes downloading to the image processing device 203 (step S510). An inquiry about the type, the number, or the like of the mounted image processing device 203 is made to the higher-level control software 302 to acquire the system information 304 and to specify information on the control target. After the information on the control target is specified, a download request for the program and the data is made, and the process ends. By referring to the system information 304, the presence or absence of the illegitimate-copy detecting processing is checked, and when it is determined that there is the illegitimate-copy detecting processing, the program and the data concerning illegitimate copying are also downloaded. The image information is scanned and is stored in a memory after being subjected to image processing by the DSP. At the time of the StoM operation, the image processing controller 201 releases the resources that have been secured for controlling the image processing device. At the same time, the image processing controller 201 reads the illegitimate-copy-detection result 305 from the illegitimate-copy detecting device 204. The image processing controller 201 sends that information to the higher-level control software 302. The higher-level control software 302 writes the illegitimate copy detection result 305 to the header of text information stored in the stored-text-information managing unit 303. When these operations are completed, the system control proceeds to a standby state again for an input of information from the operation unit 301.

As explained above, the multifunction product according to the embodiment includes the image processing system that includes the operation unit, the stored-text-information managing unit that manages stored text information, the image processing controller, the image processing device that performs predetermined image processing on the input image, and the illegitimate-copy detecting device that detects whether an illegitimate copy of the image processed by the image processing device has been made. The image processing controller is provided with the request managing unit that manages a request for a single execution request, the portion (conversion managing unit) that manages the interface protocol conversion of input information from the operation unit and stored text information managed by the stored text information managing unit, the portion (storage unit) that stores input information from the operation unit and stored text information, both subjected to interface protocol conversion, the function (unit) of achieving resource management with respect to an execution request and providing services to mounted devices, the portion (detailed information converter) that converts information, subjected to interface protocol conversion, to detailed information for downloading information to the image processing device, and the portion (downloading unit) that downloads and sets any one of program and data or both to the image processing device. The units in the image processing controller are provided separately. The portion (conversion managing unit) that manages the interface protocol conversion of input information from the operation unit and stored text information has a function of performing interface protocol conversion of detection information indicating whether an illegitimate copy of the input information from the operation unit and stored text information has been made. Therefore, the portion to be modified which depends on machine type information can be modified without changing the current architecture by adding image processing functions for stored texts and an illegitimate copy detecting function to the image processing controller as new functions. A machine that is not equipped with the storage function operates like the conventional machine by simply removing the image processing function for stored texts, thus the reusability is improved.

In the interface-protocol managing unit 502, the portion (storage unit) that stores stored text information subjected to interface protocol conversion has a function of saving detection information indicating whether an illegitimate copy of the stored text has been made.

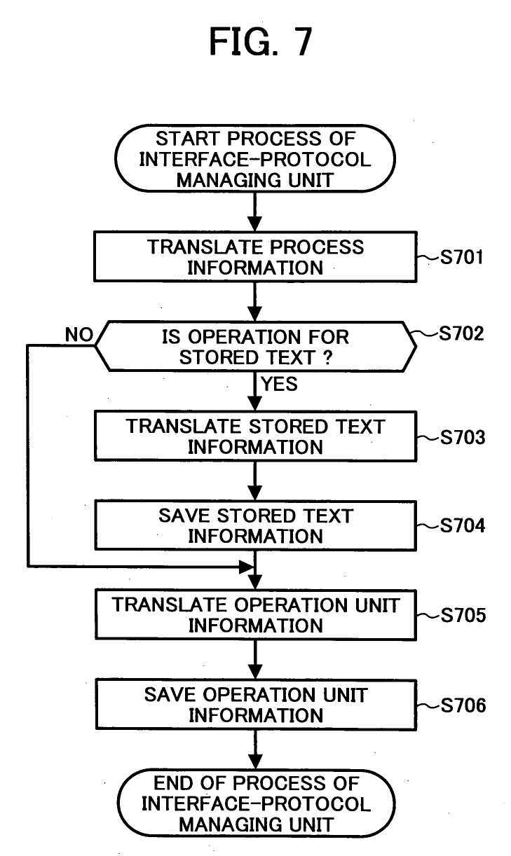

FIG. 7 is a flowchart of a processing procedure performed by the interface-protocol managing unit 502. A conventional interface-protocol managing unit performs conversion only for a copy operation. Specifically, the conventional interface-protocol managing unit only translates the information from the operation unit 301. In the interface-protocol managing unit 502 according to the embodiment, however, a stored text operation is also an operation target in addition to the copy operation control that does not store images, so that information from the stored-text-information managing unit 303 also becomes a target to be translated.

First, process information in the information from the operation unit 301 is translated (step S701). Since this information is needed in both cases of a copy operation and a stored text operation, and is also used to specify an application designated by the user, it is translated first. It is then determined whether the current operation is a stored text operation based on the process information translated at step S701 (step S702). Setting information from the operation unit 301 is necessary in both cases of the copy operation and the stored text operation, however, the information from the stored-text-information managing unit 303 is needed only for the stored text operation. It is determined from the translated process information whether the information from the stored-text-information managing unit 303 is needed in the present control and when it is determined that the information is not needed, the information is not used even if saved so that the stored text is not translated or saved. Only when it is determined that the operation is for the stored text (Yes at step S702), the stored text is translated (step S703), and the information is saved in the stored text information (internal variables) managing unit 503 (step S704). For the information from the operation unit 301, translation (step S705) and saving (step S706), which are always necessary for that information, are carried out, and the information is saved in the detailed-information conversion managing unit 505. This sequence of processing is always executed for each process. Since the process information determines whether to translate the information from the stored-text-information managing unit 303, unnecessary information will not be translated nor saved, thus accelerating the processing. Further, a single interface-protocol managing unit 502 can translate and save the information from the stored-text-information managing unit 303.

The portion (storage unit) that stores stored text information subjected to interface protocol conversion has the function of saving detection information indicating whether an illegitimate copy of a stored text has been made, so that the external influence can be minimized by translating the information to be input to the image processing controller 201 to internal variables. By handling all of the information from the operation unit 301, the stored text information, and other system information as input information to be translated, even when any one of the input information is changed, only the portion associated with the translation of that changed input information is changed, so that the internal configuration is not affected. That is, the external influence can be minimized by performing translation while handling information to be input to the image processing controller 201 as internal information and all of the information from the operation unit, the stored text information, and other system information as external information. Since a program and data to be downloaded can be determined by using information input through the operation unit 301 in addition to the collateral information of the image information, image processing that meets the demand of the user at the time of outputting image information can be executed.

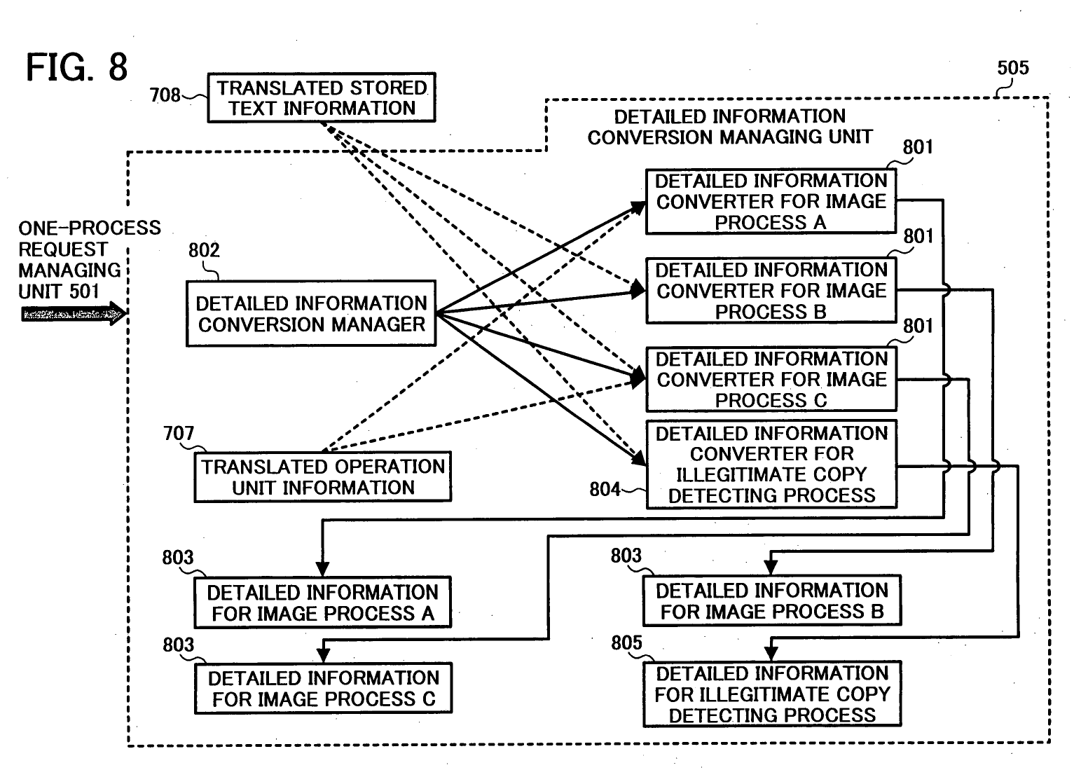

With reference to FIG. 8, the process of the detailed-information conversion managing unit 505 will be explained. In the detailed-information conversion managing unit 505, the portion (detailed information converter) that converts information subjected to interface protocol conversion to detailed information to be downloaded to the image processing device includes a controlling unit that changes the set value of any one of the program and data or both when detecting any detection information indicating that an illegitimate copy has been made from any one of the input information from the operation unit 301 and the stored text information or both, both subjected to interface protocol conversion.

FIG. 8 depicts an information reference structure of the detailed-information conversion managing unit 505. The detailed-information conversion managing unit 505 converts information to detailed information for each unit of image processing. FIG. 8 exemplifies the reference structure of information needed for conversion in a detailed information converter 801 for each image processing.

With reference to FIG. 8, the detailed-information conversion managing unit 505 includes a detailed-information conversion manager 802, the detailed information converters 801 for image processes A, B, C and the like, and a detailed information converter 804 for an illegitimate-copy detecting processing. When the one-process request managing unit 501 sends a detailed information conversion request, the detailed-information conversion manager 802 always receives this external request to the detailed-information conversion managing unit 505. The detailed-information conversion manager 802 sends conversion requests (solid lines in FIG. 8) for the respective image processes with respect to the detailed information converter 801 for each image process and the detailed information converter 804 for the illegitimate-copy detecting processing. According to the request from the detailed-information conversion manager 802, the detailed information converter 801 for each image process converts the input information to corresponding detailed information 803, and to detailed information 805 for the illegitimate-copy detecting processing. Information necessary for conversion is common to all the image processing and the information converted by the interface-protocol managing unit 502 is used. The necessary information is acquired by referring to translated operation unit information 707 for the information from the operation unit 301, and referring to translated stored text information 708 for the stored text (broken lines in FIG. 8). The detailed information converter 801 for each image process determines which image processing requires which information, and acquires only the information needed for conversion to detailed information from the respective information sources. Depending on the image processing, the translated operation unit information 707 or the translated stored text information 708, or both are needed in control, and the determination thereon is made by the image processing. Therefore, the associated portions of the detailed information converters 801 for the image processes are modified according to the control request.

After the detailed information converter 801 for each image process and the detailed information converter 804 for the illegitimate-copy detecting processing perform the respective processes, detailed information is determined and is saved as the detailed information 803 for each image process and the detailed information 805 for the illegitimate-copy detecting processing. The detailed information 803 for each image process and the detailed information 805 for the illegitimate-copy detecting processing are saved and managed as a group of detailed information by the detailed-information conversion managing unit 505.

As explained above, the portion (detailed information converter) that converts information, subjected to interface protocol conversion, to detailed information to be downloaded to the image processing device includes a controlling unit that changes the set value of any one of program and data or both when detecting detection information indicating that an illegitimate copy has been made, from any one of the input information from the operation unit and the stored text information or both, both subjected to interface protocol conversion. The variation of the control on the portion that converts the converted information to detailed information to be downloaded to the device is realized by a single image processing controller for both controls by handling not only operation unit information for a copy operation but also stored text information. The architecture of the portion that converts the converted information to detailed information to be downloaded to the device is not changed even when stored text information is handled, and it is only necessary to modify only the portion to be modified that depends on the machine type and handles a stored text and an illegitimate copy detecting function. This ensures easy incorporation even in providing another machine with the function.

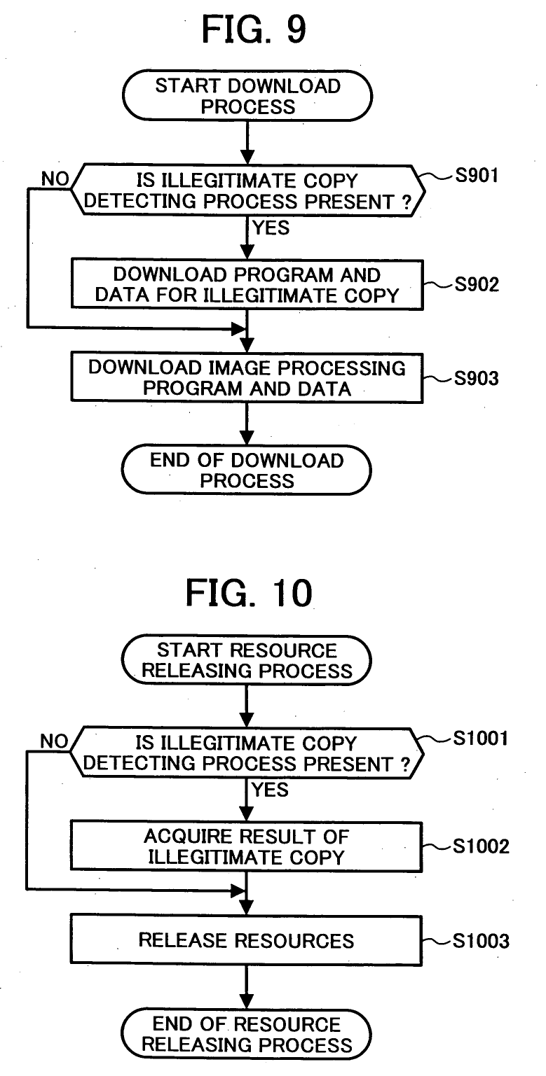

With reference to FIG. 9 to FIG. 12, the process of the download-request managing unit 506 will be explained. In the download-request managing unit 506, the portion (downloading unit) that downloads and sets any one of program and data or both to the image processing device has a function of downloading a changed set value when the portion (detailed information converter) that converts information, subjected to interface protocol conversion, to detailed information to be downloaded to the image processing device, changes the set value of any one of the program and data or both upon detection of detection information indicating that an illegitimate copy has been made.

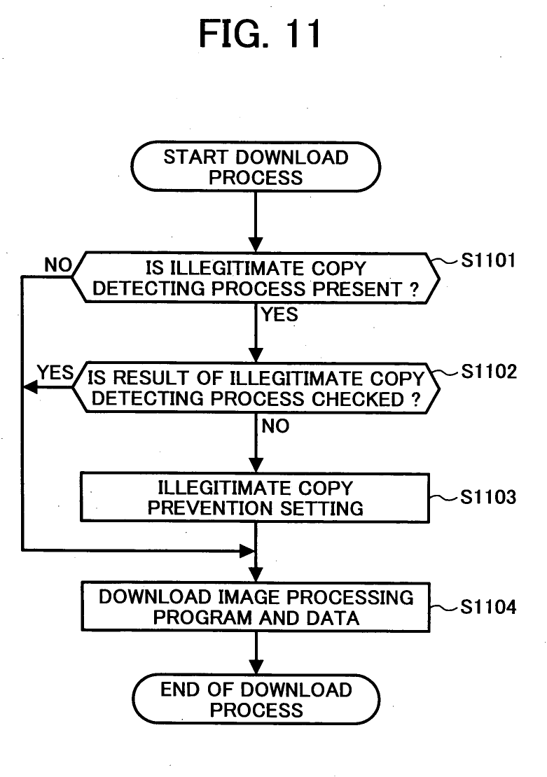

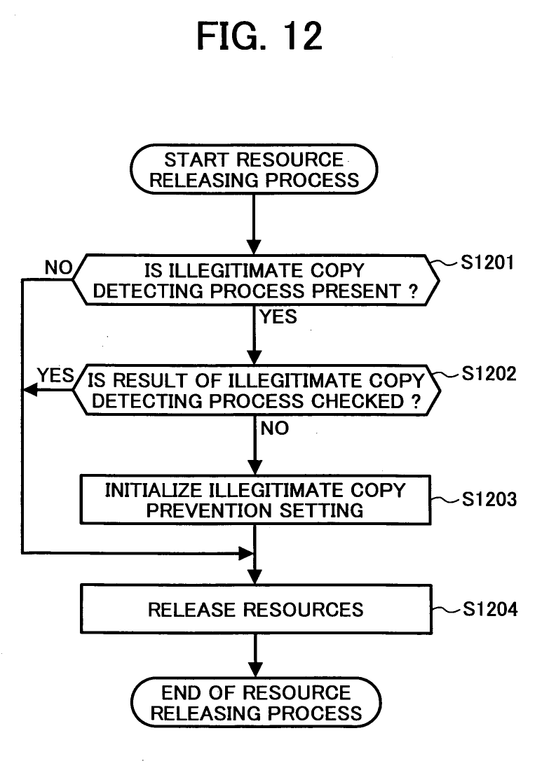

FIG. 9 and FIG. 10 are flowcharts of the process of downloading a program and data to the image processing device at the time of StoM. The flowchart shown in FIG. 9 depicts the setting process prior to image scanning, and the flowchart shown in FIG. 10 depicts the setting process after image scanning. FIG. 11 and FIG. 12 are flowcharts of the process of downloading a program and data to the image processing device at the time of MtoP. The flowchart shown in FIG. 11 depicts the setting process prior to image printing, and the flowchart shown in FIG. 12 depicts the setting process after image printing.

The StoM operations are for loading information from the scanner to the memory, such as a copy operation and a text storage operation. With reference to FIG. 9, the download-request managing unit 506 determines from the system information 304 whether the DSP that detects prevention of an illegitimate copy is installed in the image processing system (step S901). When this DSP is installed in the image processing system (Yes at step S901), a program and data for detecting an illegitimate copy (program and data for an illegitimate copy) are downloaded (step S902). A program and data for scanner correction (image processing program and data) are always downloaded regardless of the system information 304 (step S903).

With reference to FIG. 10, in the resource releasing process of sending image information to the DSP and releasing resources secured for image processing control after the scanner correction, it is determined from the system information 304 whether the DSP that detects prevention of an illegitimate copy is installed in the image processing system (step S1001), similarly to the example shown in FIG. 9. When this DSP is installed in the image processing system (Yes at step S1001), a process of acquiring the result of detection of an illegitimate copy is added (step S1002). In this process, the specific memory in the DSP for an illegitimate copy is read, and the result of the determination made by the DSP on an illegitimate copy is read and is notified to the higher-level control software 302. The higher-level control software 302 acquires the result of the illegitimate copy and writes it in the header of electric image data, and saves the resultant image data in the stored-text-information managing unit 303. The process of releasing the resources secured for image processing control is then executed (step S1003). The result of the determination on the illegitimate copy is saved as a part of collateral information of the image information.

The MtoP operations shown in FIG. 11 and FIG. 12 are for printing, such as a copy operation and a print operation. The MtoP operation, like the StoM operation, first issues a request of downloading information to the image processing device before image processing. Referring to FIG. 11, only when it is determined that the image processing system includes the illegitimate-copy detecting processing (Yes at step S1101) and it is determined that an illegitimate copy is detected from the results of the illegitimate-copy detecting processing (NG at step S1102), an unreadable setting, such as a test pattern, is made to the DSP that performs a correction processing for an MtoP print operation (step S1103). When the operation is not determined as an illegitimate copy even if it is equipped with the illegitimate copy function (OK at step S1102), the operation becomes the same as the normal operation. The normal operation is to download only the image processing program and data for a print correction process (step S1104). Referring to FIG. 12, only when the operation is determined as an illegitimate copy at the time of releasing the resources after image processing (Yes at step S1201), and unreadable setting, such as a test pattern, is made (NG at step S1202), the image becomes unreadable at the time of the next printing if the status is left unchanged, and therefore, initialization is performed (step S1203). As in the normal operation, the process ends after the resources secured for image processing control are released (step S1204).

The portion (downloading unit) that downloads and sets any one of program and data or both to the image processing device has a function of downloading a changed set value when the portion (detailed information converter) that converts information subjected to interface protocol conversion to detailed information, detects detection information indicating that an illegitimate copy has been made and changes the set value of any one of the program and data or both. The external influence can be minimized by translating external information, including information input to the image processing controller and all of the information from the operation unit, the stored text information, the information of the illegitimate copy detecting function, and other system information, to internal variables.

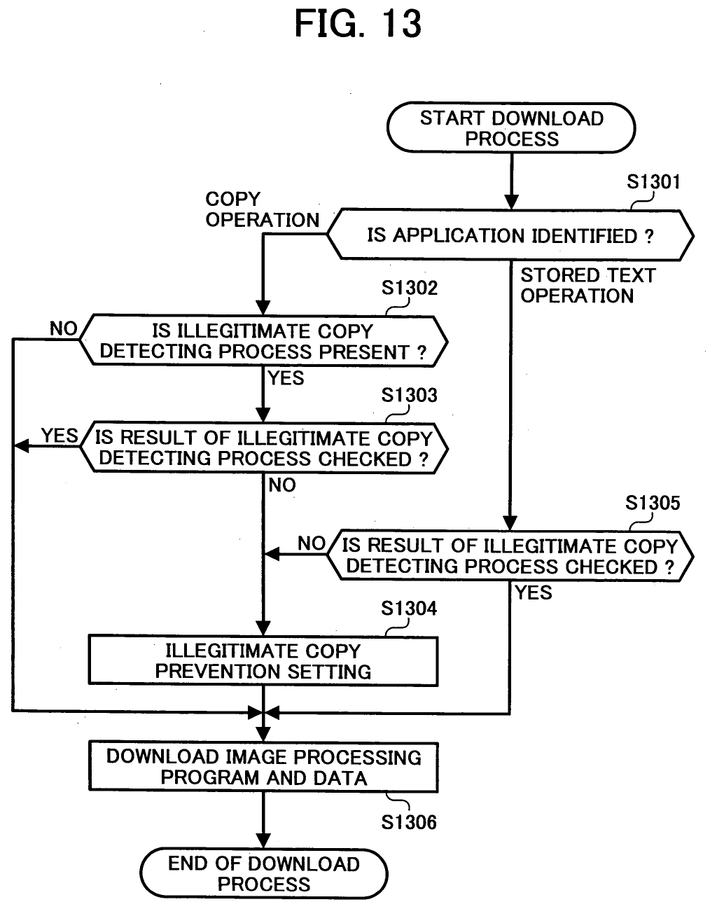

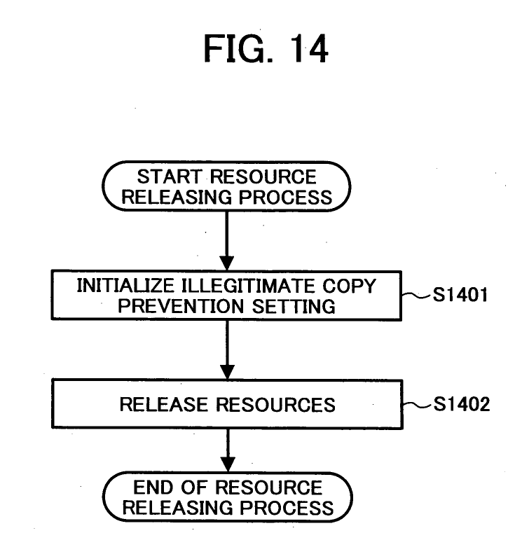

With reference to FIG. 13 and FIG. 14, the process of the download-request managing unit 506 at the time of MtoP will be explained. In the download-request managing unit 506, the portion (downloading unit) that downloads and sets any one of program and data or both to the image processing device sets detection information indicating whether an illegitimate copy has been made, at the time of performing the scanner correction image processing since there is no stored text information in normal copy operation mode, determines based on this detection information, whether an illegitimate copy has been made, and when it is determined that an illegitimate copy has been made, changes the set value of any one of the program and data or both, whereas since the scanner correction image processing is not carried out, determines-whether an illegitimate copy has been made, based on detailed information converted from stored text information by the detailed information converter (portion that converts information subjected to interface protocol conversion to detailed information to be downloaded to the image processing device), and when it is determined that an illegitimate copy has been made, changes the set value of any one of the program and data or both.

FIG. 13 and FIG. 14 are flowcharts of the process of downloading a program and data to the image processing device at the time of MtoP. The flowchart shown in FIG. 13 depicts the setting process prior to image printing, and the flowchart shown in FIG. 14 depicts the setting process after image printing. With reference to FIG. 13 and FIG. 14, the location of referring to the result of the determination on an illegitimate copy is changed between a copy operation and a stored text operation. For the copy operation (copy operation at step S1301), a copy application is selected in application discrimination and the flow becomes the same as that shown in FIG. 11. Therefore, the description with respect to FIG. 11 should be referred to for the explanation of step S1302 to step S1304 and step S1306, which will therefore be omitted. When a stored text is selected in the application selection (stored text operation at step S1301), reference to the result of an illegitimate copy differs from that in the copy operation. That is, as the result is notified as the header information of the stored text from the higher-level control software 302, it is determined whether an illegitimate copy has been made by referring to the detailed information 805 for the illegitimate-copy detecting processing or converted information of the detailed information converter 804 in the illegitimate-copy detecting processing (step S1305). The subsequent flow is the same as that in the copy operation. With regard to the initialization of the setting for illegitimate copy prevention shown in FIG. 14, the determination cannot be made with the system information 304 alone, and the initialization is carried out each time irrespective of the result of the determination on an illegitimate copy (step S1401 and step S1402). When initialization takes time, the status of the image processing device is read and the correction process is executed only when the process is the illegitimate copy prevention process. Thereafter, the resources are released as in the normal operation, and the process ends.

At the time of downloading and setting any one of program and data or both to the image processing device, since there is no stored text information in a normal copy operation mode, detection information indicating whether an illegitimate copy has been made is set at the time of performing the scanner correction image processing, it is determined based on this detection information whether an illegitimate copy has been made, and when it is determined that an illegitimate copy has been made, the set value of any one of the program and data or both is changed. On the other hand, since the scanner correction image processing is not carried out in an operation mode of printing out a stored text, it is determined whether an illegitimate copy has been made, based on detailed information converted from stored text information by the detailed information converter, and when it is determined that an illegitimate copy has been made, the set value of any one of the program and data or both is changed. Accordingly, the variation of the control on the portion that downloads and sets any one of program and data or both to the device is realized by a single image processing controller for both controls by handling not only information from the operation unit for a copy operation but also stored text information. The architecture of the portion that downloads and sets any one of program and data or both to the device is not changed even when stored text information is handled, and it is only necessary to modify only the portion to be modified that depends on the machine type and handles a stored text and an illegitimate copy detecting function. This ensures easy incorporation even in providing another machine with the function. Since a program and data are downloaded to the image processing device based on the collateral information of the image information and the system information, it is possible to perform optimal image processing including the illegitimate-copy detecting processing on image information.

Even when there is no scanner correction process with respect to the illegitimate copy prevention process in copy operation mode (process of acquiring information on illegitimate copy prevention only in the scanner correction image processing) as in the print operation, it is possible to execute the illegitimate copy prevention process as in the copy operation.

Image processing that is executed by the DSP that has downloaded a program and data corresponding to each process will be explained next. According to the image processing by the DSP, since the portion (downloading unit) that downloads and sets any one of program and data or both to the image processing device does not execute the scanner correction image processing in an operation mode of printing out a stored text, it is determined whether an illegitimate copy has been made, based on detailed information converted from stored text information by the detailed information converter (portion that converts information subjected to interface protocol conversion to detailed information to be downloaded to the image processing device), and when it is determined that an illegitimate copy has been made, the set value of any one of the program and data or both is changed.

At the time of downloading any one of program and data or both to the image processing device, as explained above, since the scanner correction image processing is not carried out in an operation mode of printing but a stored text, it is determined whether an illegitimate copy has been made, based on detailed information converted from stored text information by the detailed information converter, and when it is determined that an illegitimate copy has been made, the set value of any one of the program and data or both is changed. Therefore, even when there is no scanner correction image processing with respect to the illegitimate copy prevention process in copy operation mode (process of acquiring information on illegitimate copy prevention only in the scanner correction image processing) as in the print operation, it is possible to execute the illegitimate copy prevention process as in the copy operation.

The image processing controller 201 is modularized by function according to the embodiment. Therefore, by merely adding the part called the stored text control function to the conventional image processing controller, the image processing controller for a copy operation and a stored text and illegitimate copy detecting function as achieved by the conventional technique can be realized with a single apparatus. In an actual configuration, the image processing device 203 that executes image processing for a copy operation and a stored text, and the illegitimate-copy detecting device 204 are often the same ASIC or DSP, and achieving the control with one image processing controller 201 prevents complexity of the overall MFP system configuration. Modularization of the stored text control function enables flexible compatibility to plural types of machines by merely adding or removing the required function to or from the machine, depending on whether the machine is equipped with the storage function. It is therefore possible to flexibly cope with possible future addition of specifications to the image processing controller 201, by adding in the form of modules to the existing configuration.

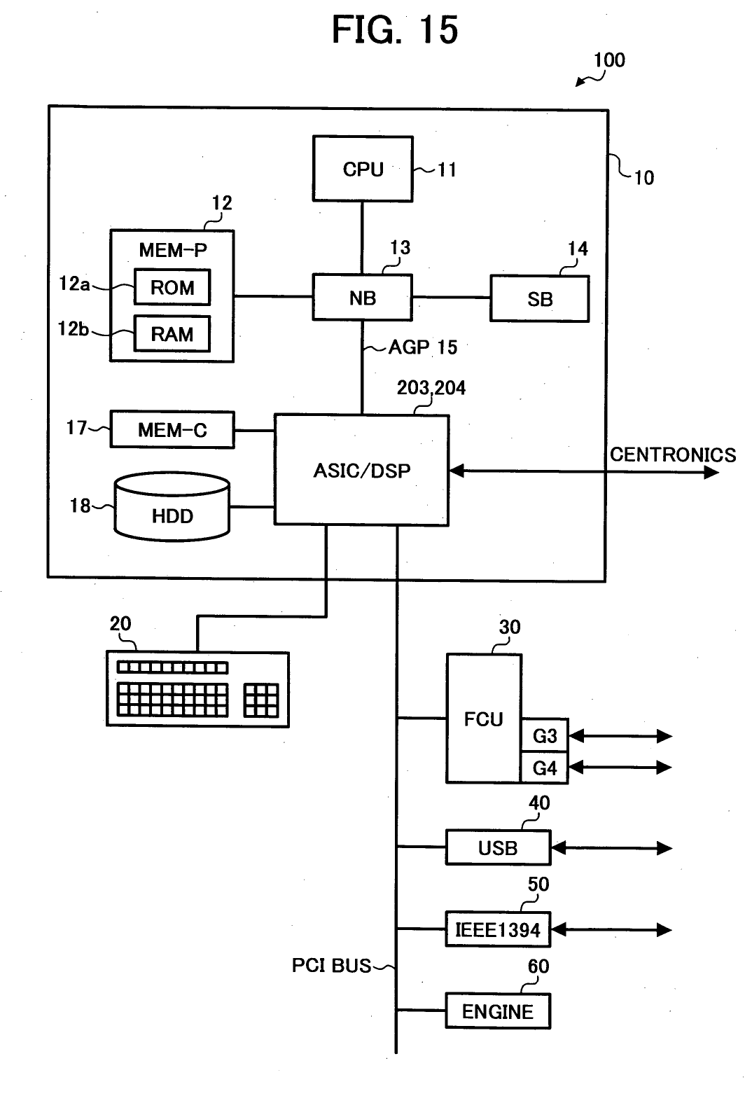

FIG. 15 is a block diagram of the hardware configuration of the copying machine 100. The copying machine 100 includes a controller 10 and an engine 60 connected together by a Peripheral Component Interconnect (PCI) bus. The controller 10 performs the general control of the copying machine 100, and controls drawing, communication, and input from an operation unit 20. The engine 60 is a printer engine or the like which is connectable to the PCI bus, and is, for example, a monochromatic plotter, a one-drum color plotter, a four-drum color plotter, a scanner, or the like. The engine 60 includes an image processor associated with error diffusion, gamma conversion and the like, in addition to a so-called engine portion such as a plotter.

The controller 10 includes a central processing unit (CPU) 11, a north bridge (NB) 13, a system memory (MEM-P) 12, a south bridge (SB) 14, a local memory (MEM-C) 17, ASIC (Application Specific Integrated Circuit)/DSPs 203 and 204, and a hard disk drive (HDD) 18. The north bridge (NB) 13 is connected to the ASIC/DSPs 203 and 204 by an AGP (Accelerated Graphics Port) bus 15. The MEM-P 12 has a ROM (Read Only Memory) 12a and a RAM (Random Access Memory) 12b.

The CPU 11, which performs the general control of the copying machine 100, has a chip set including the NB 13, the MEM-P 12, and the SB 14, and is connected to other devices through the chip set.

The NB 13 is a bridge for connecting the CPU 11 to the MEM-P 12, the SB 14, and the AGP bus 15, and has a memory controller which controls reading and writing from and to the MEM-P 12, a PCI master, and an AGP target.

The MEM-P 12 is a system memory to be used for storing a program and data, for mapping a program and data, for drawing for the printer, and the like. The MEM-P 12 includes the ROM 12a and the RAM 12b. The ROM 12a is a read only memory to be used for storing a program and data, and the RAM 12b is a random access memory to be used for mapping a program and data, for drawing for the printer, and the like.

The SB 14 is a bridge for connecting the NB 13 to the PCI device and the peripheral device. The SB 14 is connected to the NB 13 via the PCI bus to which a network interface (I/F) unit or the like is connected.

The ASIC/DSPs 203 and 204 are ICs (Integrated Circuit) specifically designed for image processing that has hardware components for image processing, and serve as a bridge to connect the AGP bus 15, the PCI bus, the HDD 18, and the MEM-C 17. The ASIC/DSPs 203 and 204 include a PCI target and an AGP master, an arbiter (ARB) that is the core of the ASIC/DSPs 203 and 204, a memory controller that controls the MEM-C 17, a plurality of DMACs (Direct Memory Access Controller) that perform rotation of image data by a hardware logic or the like, and a PCI unit that performs data transfer to and from the engine 60 via the PCI bus. An FCU (Fax Control Unit) 30, a USB (Universal Serial Bus) 40, and an IEEE 1394 (the Institute of Electrical and Electronics Engineers 1394) interface 50 are connected to the ASIC/DSPs 203 and 204 via the PCI bus.

The MEM-C 17 is a local memory td be used as a copy image buffer and a code buffer, and the HDD 18 is storage for storing image data, a program, font data, and a form.

The AGP bus 15 is a bus interface for graphics accelerator card, which is proposed to speed up the graphic processing. Since the AGP bus 15 directly accesses the MEM-P 12 with a high throughput, the speed of the graphics accelerator card is improved.

The image processing program that is executed by the copying machine 100 according to the embodiment is previously loaded in a ROM or the like and is provided in that form.

The image processing program that is executed by the copying machine 100 according to the embodiment can be provided by being recorded in an installable form or an executable form in a computer readable recording medium, such as a CD-ROM, a flexible disk (FD), a CD-R, or a DVD (Digital Versatile Disk).

Alternatively, the image processing program that is executed by the copying machine 100 according to the embodiment can be provided by being stored in a computer connected to a network such as the Internet, and downloaded over the network. The image processing program that is executed by the copying machine 100 according to the embodiment can be provided or distributed over a network such as the Internet.

The image processing program that is executed by the copying machine 100 according to the embodiment takes a module configuration including the above-described individual units (the operation information acquiring unit, the document reader, the automatic detector, the scanner image processor, the illegitimate copy detector, the collateral information creating unit, the printer image processor, or the like), and as the actual hardware, the CPU (processor) reads the image processing program from the ROM and executes it so that the individual units, namely, the operation information acquiring unit, the document reader, the automatic detector, the scanner image processor, the illegitimate copy detector, the collateral information creating unit, the printer image processor, and the like are loaded and generated on the main memory.

According to the present invention, stored image data can be printed out appropriately by performing image processing using optimal image processing parameters regardless of the type of the image data, and making of illegitimate copies can be prevented.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an acquiring unit that acquires image information and collateral information, wherein the collateral information includes illegitimate-copy-detection information that indicates whether the image information is an illegitimate copy; and
an output unit that outputs the image information in an unreadable form when the illegitimate-copy-detection information indicates that the image information is an illegitimate copy.

2. The image processing apparatus according to claim 1, further comprising:
a detecting unit that detects whether the image information is an illegitimate copy; and
a creating unit that creates the illegitimate-copy-detection information based a result of detection by the detecting unit.

3. The image processing apparatus according to claim 1, further comprising:
a receiving unit that receives the image information and the collateral information and passes received image information and collateral information to the acquiring unit.

4. The image processing apparatus according to claim 2, further comprising:
a plurality of devices that performs image processing;
a translating unit that translates the collateral information to internal data;
a converting unit that converts the internal data to detailed information corresponding to a program and data used for the image processing; and
a downloading unit that downloads the program and the data to the devices based on the detailed information and system information indicating whether a first device that performs illegitimate-copy detecting processing is included among the devices, wherein
when the system information indicates that the first device is included, the detecting unit detects whether the image information is an illegitimate copy by using the first device to which a program and data concerning the illegitimate-copy detecting processing is downloaded by the downloading unit.

5. The image processing apparatus according to claim 4, wherein when the system information indicates that the first device is included, the output unit outputs the image information by using the first device.

6. The image processing apparatus according to claim 4, further comprising an obtaining unit that obtains operation data set for outputting the image information, wherein
the translating unit further translates the operation data to operation-internal data, and
the converting unit converts the internal data to detailed information based on the internal data and the operation-internal data.

7. The image processing apparatus according to claim 1, further comprising a storing unit that stores therein the image information and the collateral information acquired by the acquiring unit in an associated manner, wherein
the output unit outputs the image information stored in the storing unit in an unreadable form when the illegitimate-copy-detection information indicates that the image information is an illegitimate copy.

8. A method comprising:
acquiring image information and collateral information, wherein the collateral information includes illegitimate-copy-detection information that indicates whether the image information is an illegitimate copy; and
outputting the image information in an unreadable form when the illegitimate-copy-detection information indicates that the image information is an illegitimate copy.

9. A computer-readable recording medium that stores therein a computer program that causes a computer to execute:
acquiring image information and collateral information, wherein the collateral information includes illegitimate-copy-detection information that indicates whether the image information is an illegitimate copy; and
outputting the image information in an unreadable form when the illegitimate-copy-detection information indicates that the image information is an illegitimate copy.
